(19) United States
(12) Patent Application Publication
(10) Pub. No.: US 2006/0108739 A1
(43) Pub. Date: May 25, 2006

(54) Apparatus and method for scent identification

(76) Inventor: Elea Brewer Lutz, Scottsdale, AZ (US)

Correspondence Address: ELEA BREWER LUTZ, 14887 North 103rd Street, Scottsdale, AZ, 85255, US

(21) Appl. No.: 10/997,335

(22) Filed: Nov. 23, 2004

(51) Int. Cl. A01M 1/00

(52) U.S. Cl. 273/292

(57) ABSTRACT

Disclosed are apparatuses and methods for teaching a person, particularly a child, to identify an object associated with a scent. The object can be any substance, material or thing, such as root beer, banana, vanilla or mint, having an identifiable scent. The apparatus includes at least one scented device, which is most preferably a playing card. Also included as part of the apparatus is indicia of the identity of the object. The indicia of identity may be located anywhere, such as on a sheet of paper, board or container, but is preferably located on the device at a position where it cannot be readily detected by someone smelling the device. Optionally, the apparatus also includes indicia of one or more clues of the identity of the object and/or indicia of one or more things related to the object. One method by which a person uses the apparatus is by smelling the device and guessing the identity of the object. The guess is then compared to the indicia of identity of the object to determine if the guess is correct. One or more clues may be used to assist the user to guess the identity of the object. If the object is guessed correctly, the user may attempt to spell the name of the object, identify the appearance of the object, and/or guess things related to the object. Score may be kept based on correct or incorrect guesses and multiple users may engage in competitive play.

### FIELD OF THE INVENTION

The invention relates to apparatuses and methods used by a person to identify an object associated with a scent, and optionally to spell the name of the object, identify the appearance of the object and/or identify things related to the object.

### BACKGROUND OF THE INVENTION

Smell is a sense that enables an individual to perceive the scent (also called an odor or fragrance) of an object (as used herein, “object” refers to any substance, material or thing that has a scent). Throughout history, the sense of smell had been used in virtually every culture and in many religions. For example, in the Greek Orthodox Church incense is burned to appeal to the sense of smell. In Judaism, a spice box including pungent and pleasant spices, such as cinnamon, cloves, and cardamom are used in the Havdalah service, which is held at the end of the Sabbath to start the new week afresh.

Aromatherapy was perhaps first practiced by the ancient Egyptians. Egyptian priests used different scents, generated by burning aromatic substances such as crushed cedarwood bark, caraway seeds, or angelica roots steeped in wine or oil, to either exhilarate or relax their congregations. Kyphi, which is a mixture of sixteen essences, including myrrh and juniper, was used to raise spiritual awareness and heighten the senses. Incense is still used today for much the same purpose.

There is also believed to be a link between smell and memory. It was reported in The Boston Globe that people of different generations experience nostalgic feelings triggered by different odors. For example, some people born in the 1920's, 30's or 40's may feel nostalgic when smelling flowers, sea air, cut grass or burning leaves, whereas those born in the 50's, 60's or 70's may feel nostalgic when smelling Play-Doh, window cleaner, hair spray, suntan lotion or felt-tip pens. One researcher hypothesizes that deja-vu is a phenomenon whereby a scent too faint to be consciously perceived still registers in the subconscious mind to trigger a memory.

Today scientists are trying to learn more about the power of the sense of smell. Studies have shown that certain smells can be helpful in enhancing relaxation. One of the most well-known studies was done at Sloan-Kettering Memorial Hospital on patients undergoing magnetic resonance imaging (MRI), where a patient must lie motionless while his or her internal organs are scanned. When the vanilla-like aroma of heliotrope was introduced to patients undergoing MRI scans, 63% showed reduced anxiety. In another study at Renssalaer Polytechnic Clinic, it was found that scenting a room with spiced apple or “powder fresh” GLADE air freshener improved performance on a high-stress task. No conclusion was reached as to whether the effects of the fragrance were physical or simply due to cognitive distraction, i.e., the fragrance may have elicited pleasant memories or moods that served as a distraction from anxiety.

The Walt Disney World Magic House at Epcot Center in Florida has a room scented with the smell of fresh-baked chocolate chip cookies to induce feelings of relaxation and comfort. In Japan, the Shimizu construction company uses an “aromatherapeutic environmental fragrancing” system in which air-conditioning ducts hidden in ceiling tiles release a mixture of eight therapeutic aroma chemicals about every six minutes. The system releases different fragrances to improve alertness and concentration, alleviate stress, or to relax workers at the end of the day. Russian psychologists at the Russian Academy of Sciences found that the smells of fruit and flowers can ease the load of computer operators, who spend long hours in front of computer screens each day. Lemon, jasmine or eucalyptus was found to boost productivity and prevent drowsiness.

The sense of smell is sometimes dulled by factors such as smoking and drinking, but children are believed to be highly responsive to scents. Yet the sensitivity of children to scents is rarely used as an educational tool and scent has been included as an element in just a few apparatus used to teach children. For example, U.S. Pat. No. 4,687,203 to Spector discloses a scratch and smell apparatus for pre-school children that includes a playing board having a front face printed with images of different fruits or other objects, each having a characteristic scent. The apparatus is essentially a puzzle wherein both the visual and olfactory senses of the player are utilized.

U.S. Pat. No. 3,570,139 to Ladd, et.al. discloses a book made of sheets having coatings thereon that when scratched give off particular scents and pictures of selected objects, such as peppermint candy, that respectively correspond to the scents.

U.S. Pat. No. 5,918,882 to Truong discloses a game for testing the acuity of the senses and provides questions relating to the senses of touch, taste, hearing and smell of each of the players.

Lacking in the prior art is a simple apparatus or method that among, other things, enables a person, particularly a child, to attempt to identify an object associated with a particular scent. Nor is there an apparatus or method that links the identification of an object associated with a scent to learning to spell the name of the object and/or to attempt to identify things related to the object.

### SUMMARY OF THE INVENTION

The invention is an apparatus and method that can be used by a person or persons, particularly a child, to identify an object associated with a scent. One component of an apparatus according to the invention is a device having a scent (as used herein, each of the expressions “having a scent,” “have a scent,” “having the scent of an object” and “has a scent” means that the device is either scented, has a scented material applied thereto or is a device such as a machine or spray canister that can generate a scent).

The device may be any structure that has a scent, particularly one that can be held in the hand, and is most preferably a playing card. Any method or substance may be employed to cause the device to have a scent, as long as the scent is detectable by a person having at least an ordinary sense of smell. A preferred device has a scented material, such as a microencapsulated formulation, applied thereto preferably by a printing process. If a microencapsulated formulation is used, it releases a scent either by the application of pressure, water, heat, a chemical or other stimulus to the formulation, or the formulation may be one that releases a scent without the application of an external stimulus. Further, the device having the scent of an object may be a machine that generates a scent in response to an electronic signal or in response to an analog signal, such as from a person pressing a button, or may be any other device having a scent.

Also provided is indicia of the identity of the object (for example, “banana”) associated with the scent. The indicia of identity of the object may be one or more of the following: (a) one or more words (as used herein “words” refers to words conveyed in any manner, such as printed words, electronically displayed words or words audibly communicated), such as the name of the object, (b) one or more pictorial representations (such as one or more photographs or drawings of the object), and (c) any other indicia (such as Braille characters) by which the object may be identified. The indicia of identity of the object could be provided anywhere on the apparatus, and is preferably located on the device at a position where the user cannot readily detect it (either visually or through touch) while smelling the scent. Using the example of a banana, indicia of the identity of the object could include one or more of the following: the word “banana,” a picture or drawing of a banana or a bunch of bananas, and Braille characters that spell “banana.”

Optionally, the apparatus includes the correct spelling of the name of the object and, if provided, the correct spelling of the name is preferably all or part of the indicia of identity of the object. The correct spelling of the name of the object could be located anywhere on the apparatus, and is preferably located on the device at a position where the user cannot readily detect it (either visually or through touch) when smelling the scent.

Optionally, the apparatus includes indicia of one or more clues of the identity of the object. The indicia of one or more clues may be one or more of the following: (a) one or more words, (b) one or more pictorial representations (such as photographs or drawings), and (c) any other indicia (such as Braille characters) by which the one or more clues related to the identity of the object can be conveyed to a person. The indicia of one or more clues could be provided anywhere on the apparatus, and is preferably located on the device at a location where the user cannot readily detect it (either visually or through touch) while smelling the scent. Returning to the example of a banana, exemplary clues might be “Grows on trees,” “Monkeys eat them,” “Used to make banana splits,” “Starts with a ‘B’” and/or a pictorial representation of a bunch of bananas, a banana tree, and/or a picture of a banana itself.

Optionally, the apparatus also includes indicia of one or more things related to the object. The indicia of one or more things related to the object may be one or more of the following: (a) one or more words, (b) one or more pictorial representations (such as photographs or drawings), and (c) any other indicia (such as Braille characters) by which the one or more things related to the object can be conveyed to a person. The indicia of one or more things related to the object may be located anywhere on the apparatus. Again returning to the example of a banana, exemplary things related to a banana might be other fruits (such as apples, grapes, blueberries, oranges, peaches and/or pears), things that grow on trees (which would exclude fruits such as grapes and blueberries, but include items such as acorns and almonds), and/or things in which bananas are used (such as ice cream, pie, and/or bread).

The apparatus may include one or more of the following: software, a structure to read magnetic or other electronic code, such as bar code (all such codes are collectively referred to hereafter as “electronic code”), a computer or other machine that can operate the software (collectively referred to hereafter as “computer”), an electronic display and/or a sound generation machine that can mimic human speech. Using a combination of these structures or machines one or more of the identity of the object, correct spelling of the name of the object, indicia of one or more clues of the identity of the object and indicia of one or more things related to the object could be conveyed to a person, such as by being electronically displayed or conveyed audibly.

An apparatus according to the invention may also include a container for storing all or part of the other structures of the apparatus. If provided, the container preferably has a scent associated with an object.

In one preferred method of using the apparatus, the user smells the device having a scent and guesses the identity of the object associated with the scent. Another person, or the user, then compares the guess to the indicia of identity of the object to verify whether the guess was correct. Optional aspects of a method according to the invention include providing one or more clues of the identity of the object, attempting to spell the name of the object, attempting to identify the appearance of the object, attempting to identify things associated with the object, and/or keeping score for correct and/or incorrect answers. Multiple users may also engage in competitive play.

### BRIEF DESCRIPTION OF THE DRAWINGS

FIG. 1 is a front view of a device according to the invention, wherein the device is a card.

FIG. 2 is a rear view of the device of FIG. 1.

FIG. 2a shows exemplary indicia of things related to an object according to the invention.

FIGS. 2b-d show alternate devices that may be used to practice the invention.

FIG. 3 is a side view of a container according to the invention.

FIG. 4 is a top view of the bottom section of the container of FIG. 3.

FIG. 5 is a bottom view of the top section of the container of FIG. 3.

FIG. 6 is a side view of the container of FIG. 3 showing the top section fitting over the bottom section.

FIG. 7 is an alternate apparatus that may be used to practice the invention.

FIG. 8 is a flow chart of a method according to the invention.

FIG. 9 is a flow chart showing optional method steps according to the invention.

FIG. 10 is a flow chart showing optional method steps according to the invention.

FIG. 11 is a flow chart showing optional method steps according to the invention.

FIG. 12 is a flow chart showing optional method steps according to the invention.

FIG. 13 is a flow chart showing optional method steps according to the invention.

### DETAILED DESCRIPTION OF THE PREFERRED EMBODIMENTS

An apparatus according to the invention includes at least (a) a device having the scent of an object, and (b) indicia of the identity of the object. Optionally, an apparatus according to the invention could include one or more of: the correct spelling of the name of the object (which is preferably part of the indicia of identify of the object), indicia of one or more clues of the identity of the object, indicia of one or more things related to the object, and items or structures such as a board, a card reading device, software, a computer, an electronic display, an electronic code reader, a machine that mimics human speech, a score card, a paper pad, a timer, a dye or dice, a blindfold and/or a container. The indicia of the identity of the object, the correct spelling of the name of the object, the indicia of one or more clues of the identity of the object, and the indicia of one or more things related to the object could each be located anywhere on the device or located anywhere else on the apparatus, could each be displayed (either electronically or by being printed), be part of an electronic code, or be conveyed to a person in any manner, and may or may not each be at the same location or each be conveyed to a person in the same manner.

The object can be anything having a distinctive scent, and a non-exhaustive list of objects follows: root beer, cola, vanilla, chocolate, mint, peanut butter, apple, orange, grapefruit, peach, cinnamon, leather, ocean, burning rubber, cut grass, carrot, hard-boiled egg, butterscotch, strawberry, banana, blueberry, bubblegum, lavender, rose, pepper, clove, coffee, tea, tomato sauce, oregano, mustard, magic marker, pumpkin pie, raspberry, lemon, vinegar, dill, pineapple, sour apple, almond extract, licorice, cotton candy, popcorn, cherry, pine, chicken noodle soup, macaroni and cheese, hot dog, ginkgo, olive, jasmine, cedar, juniper, ginger, myrrh, truffle, chocolate chip cookies, pizza, and eucalyptus.

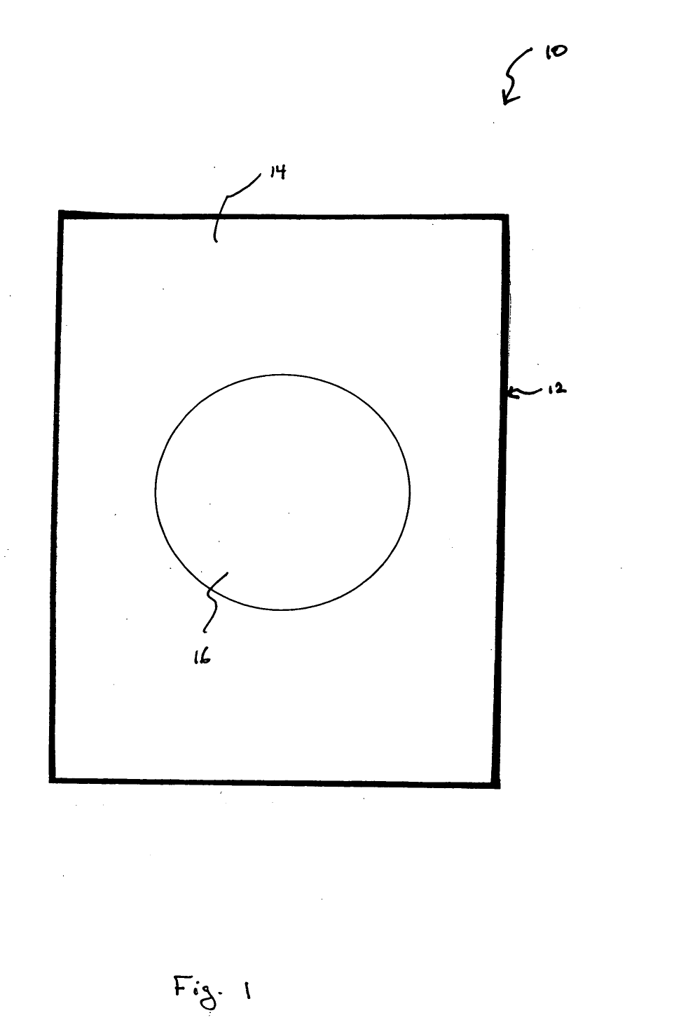

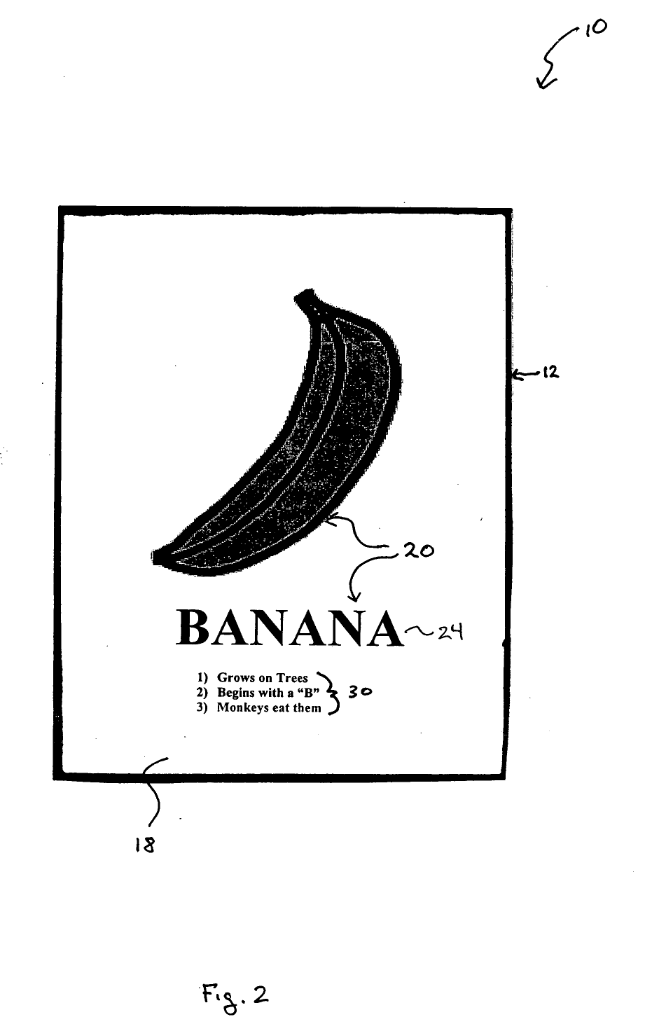

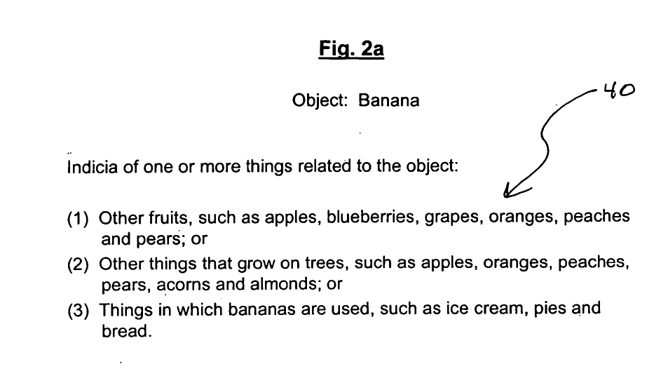

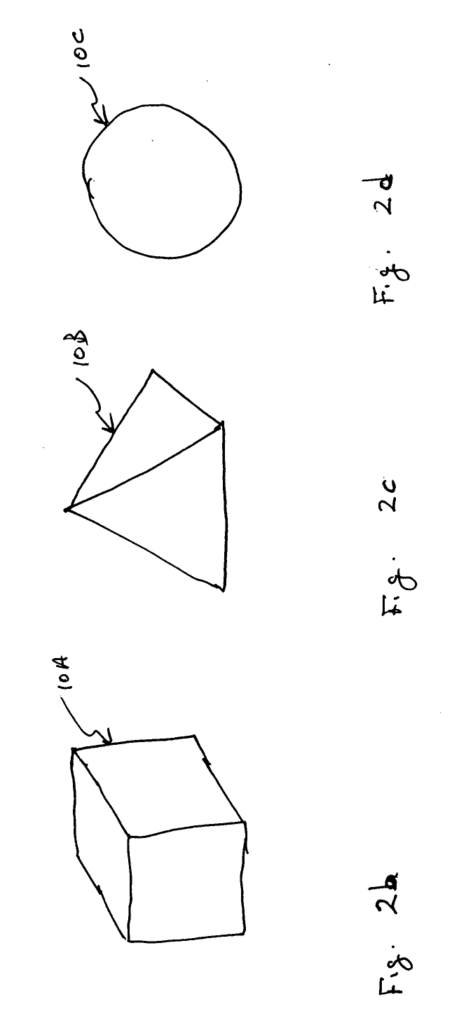

Turning now to the drawings, where the purpose is to describe a preferred embodiment of the invention and not to limit same, FIGS. 1 and 2 show a device 10. Device 10 has a scent associated with an object. Device 10 may be any structure having a scent, but device 10 is not itself the object, although it could be configured to resemble the object associated with the scent or colored to invoke an association with the object. For example, if the object were a banana, device 10 could be shaped as a banana and/or could be entirely or partly yellow to invoke an association with a banana.

Any method or substance may be employed to cause device 10 to have a scent, as long as the scent is detectable by a person having at least an ordinary sense of smell. For example, if device 10 is scented, the scent may be applied to device 10 by scenting the plastic, rubber, paper, cardboard or other material used to manufacture device 10, by applying a scented strip or area to device 10, or by applying a scented material, such as perfume, oil, a microencapsulated formulation, or other substance directly to device 10. Device 10 may also be (a) a machine that generates a scent, such as the Scent Dome, manufactured by Telewest Broadband of the United Kingdom, or a scent storage device such as disclosed in U.S. Pat. No. 6,737,025 to Boyd, et. al., the disclosure of which is incorporated herein by reference, (b) a spray bottle or canister, or (c) any structure or device having a scent associated with an object.

Preferably, device 10 is scented by having a scented material applied thereto during a printing process, and this method is well known to persons skilled in the art of printing scented paper products or novelty devices. The scented material is preferably a microencapsulated formation that does not readily dissipate. If a microencapsulated formulation is used with the invention, it would release a scent either by the application of pressure, water, heat, a chemical or other stimulus to the formulation, or the formulation may be one that gradually releases a scent without the application of an external stimulus.

Microencapsulated formulations that release a scent are well known in the art. Some patents disclosing microencapsulated formulations, scented inks or other materials that could be used with the invention are: U.S. Pat. No. 4,661,388 to Charbonneau; U.S. Pat. No. 5,577,947 to Malloy, et. al.; U.S. Pat. No. 6,123,757 to Yang, et. al.; U.S. Pat. No. 6,737,025 to Boyd, et. al.; U.S. Pat. No. 3,655,129 to Seiner; U.S. Pat. No. 3,688,985 to Engel; U.S. Pat. No. 6,454,842 to Vernardakis; U.S. Pat. No. 6,706,099 to Sir, et. al.; U.S. Pat. No. 3,909,444 to Anderson, et. al.; and U.S. Pat. No. 6,318,589 to Simpson, the respective disclosures of which are hereby incorporated by reference.

Turning again to FIGS. 1-2, device 10 is most preferably a playing card 12, which can be of any suitable size or shape and may be comprised of any suitable material, such as cardboard or plastic. Card 12 has a first face 14 that optionally includes a scented area 16, and a second face 18. Face 14 and/or face 18 may also include one or more patterns, designs, logos or words unrelated to the functioning of the invention. Area 16 includes a scented material applied thereto. The scented material is preferably a microencapsulated formula applied during a printing process, wherein the preferred microcapsules on area 16 are ruptured when pressure is applied by a user, such as by rubbing or scratching the microcapsules. Area 16 may be of any shape, size or color as long as it is sufficiently large enough to enable a person with ordinary sense of smell to detect the scent. For example, area 16 may simply be circular, as shown, and be of any color. Area 16 may instead have the color and/or shape of the object associated with the scent. Alternatively, device 10 may include a plurality of scented areas of any size, shape or color.

FIGS. 2b-2d show alternate devices, namely a cube 10A, sphere 10B and a pyramid 10C. If utilized, cube 10A, sphere 10B and/or pyramid 10C have a scent associated with an object.

An apparatus according to the invention could have any number of devices, such as for example, up to 10, 20, 30, 40, 50 or more devices. In the preferred embodiment the apparatus includes a plurality of cards 12, wherein each card 12 has a scent that is different than the scent of each of the other cards. In this manner, a user can learn many objects associated with their respective scents, and optionally learn the spelling of the names of each of the multiple objects and/or learn the things related to each of the multiple objects. If a device according to the invention is a machine that generates a scent, it is preferred that there is just one machine that can generate the respective scents of multiple objects.

Indicia 20 of identity of the object may be one or more of the following: (a) one or more words (such as the name of the object), (b) one or more pictorial representations (such as one or more photographs or drawings of the object), and (c) any other indicia (such as Braille characters) by which the object may be identified. Indicia 20 of identity of the object may be positioned anywhere, such as in or on device 10 or any other device used with the invention, or a sheet of paper, container, board, or other structure. In the embodiment shown in FIG. 2 , indicia 20 of identity of the object is on device 10 at a location where indicia 20 cannot be readily detected (either visually or through touch) by a user when smelling device 10. Specifically, when device 10 is card 12, indicia 20 of identity of the object is preferably positioned on second face 18 of card 12, opposite first face 14, which in the embodiment shown includes scented area 16. Optionally, a blind fold or other structure may be used to block a user's view of indicia 20 of identity of the object when the user smells device 10 or guesses the identity of the object associated with the scent.

Using the example of a banana, indicia 20 of the identity of the object could include one or more of the following: the word “banana,” a picture or drawing of a banana or a bunch of bananas, and Braille characters that spell “banana.”

If the device is a cube 10A, and indicia 20 is on cube 10A, indicia 20 is preferably positioned on one or more faces of cube 10A such that indicia 20 cannot be detected (either visually or through touch) when a user smells cube 10A. Similarly, if the device is a sphere 10B or pyramid 10C, and indicia 20 is on the device, indicia 20 is preferably positioned on the device at a location where it cannot be readily detected when a user smells the scent of the device. If device 10 is a machine or other structure that generates a scent, indicia 20 may be located anywhere on the device at a location where it cannot be readily detected by a user smelling the scent, or may be located on another structure of the apparatus.

Optionally, the apparatus includes the correct spelling 24 of the name of the object and, if provided, correct spelling 24 is preferably part of indicia 20 of identity of the object. Correct spelling 24 of the name may be communicated to a person in any manner, and is preferably a printed or displayed word, Braille characters, or audible communication of the spelling of the name. Correct spelling 24 of the name of the object may be located anywhere, such as in or on device 10 or any other device used with the apparatus, or on a sheet of paper, container, board, or other structure of the apparatus. In the preferred embodiment shown in FIG. 2, the correct spelling of the name of the object is part of indicia 20 and is located on device 10.

Optionally, the apparatus may include indicia 30 of one or more clues of the identity of the object. Indicia 30 of one or more clues can be anything to assist a user in guessing the identity of the object associated with the scent of device 10. Indicia 30 is preferably one or more of the following: (a) one or more words, (b) one or more pictorial representations (such as photographs or drawings), and (c) any other indicia (such as Braille characters) by which the one or more clues related to the identity of the object can be conveyed to a person. Indicia 30 of one or more clues may be positioned anywhere, such as in or on device 10 or any other device used with the apparatus, or on a sheet of paper, board, container, or other structure. In the embodiment shown in FIG. 2, indicia 30 of one or more clues is on device 10 at a location where indicia 30 cannot be readily detected (either visually or through touch) by a user when smelling device 10. Specifically, when device 10 is card 12, indicia 30 of one or more clues is preferably positioned on second face 18 of card 12 opposite first face 14, which in the embodiment shown includes scented area 16. Optionally, a blind fold or other structure may be used to block a user's view of indicia 30 of one or more clues of the identity of the object when smelling device 10.

If the device is a cube 10A, and indicia 30 is on cube 10A, indicia 30 is preferably positioned on one or more faces of cube 10A such that indicia 30 cannot be detected (either visually or through touch) when a user smells cube 10A. Similarly, if the device is a sphere 10B or pyramid 10C, and indicia 30 is on the device, indicia 30 is preferably positioned on the device at a location where it cannot be readily detected when a user smells the scent of the device. If device 10 is a machine or other structure that generates a scent, indicia 30 may be located anywhere on the device at a location where it cannot be readily detected by a user smelling the scent, or may be located on another structure of the apparatus.

If the object were a banana, exemplary indicia 30 of one or more clues would be “Grows on Trees,” “Monkeys eat them,” “Used to make banana splits,” or a pictorial representation of a bunch of bananas, a banana tree and/or a picture of a banana itself. If the object were a pizza, exemplary clues would be “Has a crust with tomato sauce and cheese on top,” “Is cut into slices,” “Can have toppings like mushrooms and pepperoni,” and/or a pictorial representation of a slice of pizza, someone making a pizza and/or a picture of a pizza itself.

Turning to FIG. 2a, optional indicia 40 of one or more things related to the object may be one or more of the following: (a) one or more words, (b) one or more pictorial representations (such as photographs or drawings), and (c) any other indicia (such as Braille characters) by which the one or more things related to the object can be conveyed to a person. Optional indicia 40 of one or more things related to the object may be located anywhere, such as in or on device 10 or any other device used with the apparatus, or on a sheet of paper, board, container, or other structure. Indicia 40 of one or more things related to the object may be on device 10 at a location where indicia 40 cannot be readily detected (either visually or through touch) by a user when smelling device 10. Specifically, in the case where device 10 is card 12, and indicia 40 of one or more things related to the object is on card 12, indicia 40 would preferably be positioned on second face 18 of card 12 opposite first face 14, which in the embodiment shown includes scented area 16. Optionally, a blind fold or other structure may be used to block a user's view of indicia 40 when smelling the device or guessing one or more things related to the object.

If the device is a cube 10A, and indicia 40 is on cube 10A, indicia 40 is preferably positioned on one or more faces of cube 10A such that indicia 40 cannot be detected (either visually or through touch) when a user smells cube 10A. Similarly, if the device is a sphere 10B or pyramid 10C, and indicia 40 is on the device, indicia 40 may be positioned on the device at a location where it cannot be readily detected when a user smells the scent of the device. If device 10 is a machine or other structure that generates a scent, indicia 40 may be located anywhere on the device at a location where it cannot be readily detected by a user smelling the scent, or may be located on another structure of the apparatus.

If the object were a banana, exemplary indicia 40 of one or more things related to the object might be other fruits (such as apples, grapes, blueberries, oranges, peaches and/or pears), things that grow on trees (which would exclude fruits such as grapes and blueberries, but include items such as acorns and almonds), and/or things in which bananas are used (such as ice cream, pies, and/or bread). If the object were a pizza, exemplary indicia of one or more things related to the object might be other things made with dough (such as bread or cookies) or other things including tomato sauce or cheese (such as spaghetti or macaroni with cheese).

Alternatively, indicia 20, one or both of optional indicia 30 or 40, correct spelling 24 of the name of the object and/or other information may be provided electronically. For example, a device having the scent of an object may also have an electronic code that includes indicia 20 of the identity of the object. Device 10 may be scanned or swiped, or placed on or into a machine that reads the electronic code including indicia 20 of identity of the object, these technologies being known to persons skilled in the relevant art. Indicia 20 may then be visually displayed as words or pictorial representations or conveyed by sounds mimicking human speech or by a recording of human speech. Optional indicia 30 and/or 40 and/or correct spelling 24 of the name of the object or other information may be displayed or conveyed in the same manner.

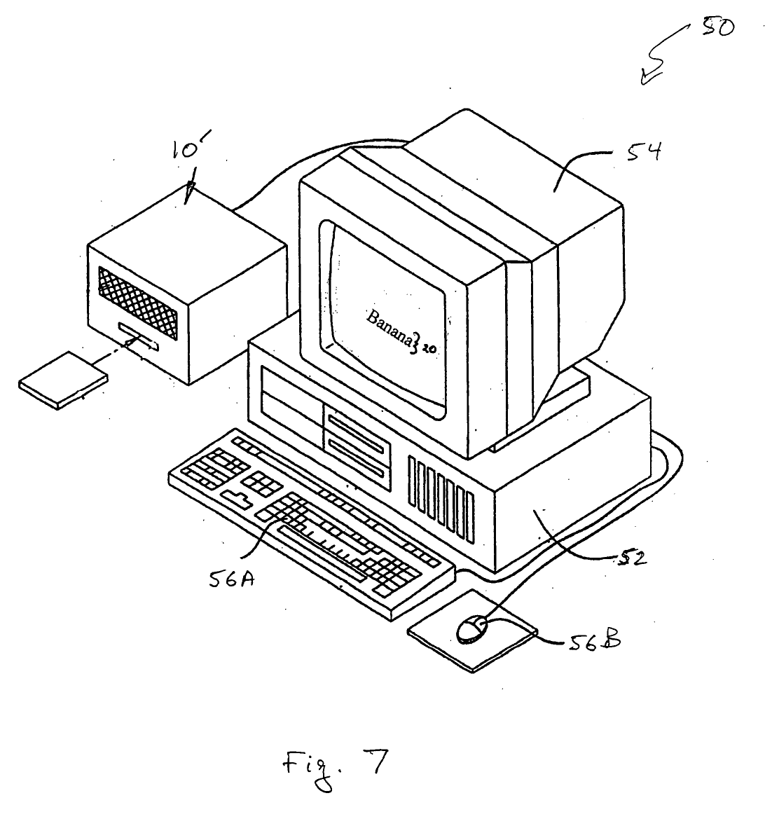

Turning now to FIG. 7, an alternate apparatus 50 according to the invention is shown. Apparatus 50 includes a computer 52, a display 54, two information input structures 56A (a keyboard) and 56B (a mouse) and a device 10′ that has a scent associated with an object. Device 10′ is a machine that generates a scent, such as the Scent Dome, manufactured by Telewest Broadband or (preferably) a scent storage device such as disclosed in U.S. Pat. No. 6,737,025 to Boyd, et. al. Any other device, such as a spray canister or previously described card 12, cube 10A, pyramid 10B or sphere 10C may instead be used. Device 10′ generates a particular scent in response to an electronic signal, such as a signal from computer 52. Software (not shown) is operated on computer 52 and could display one or more of indicia 20, 30 and 40 and correct spelling 24 of the name of the object, preferably in response to input entered via structures 56A and 56B.

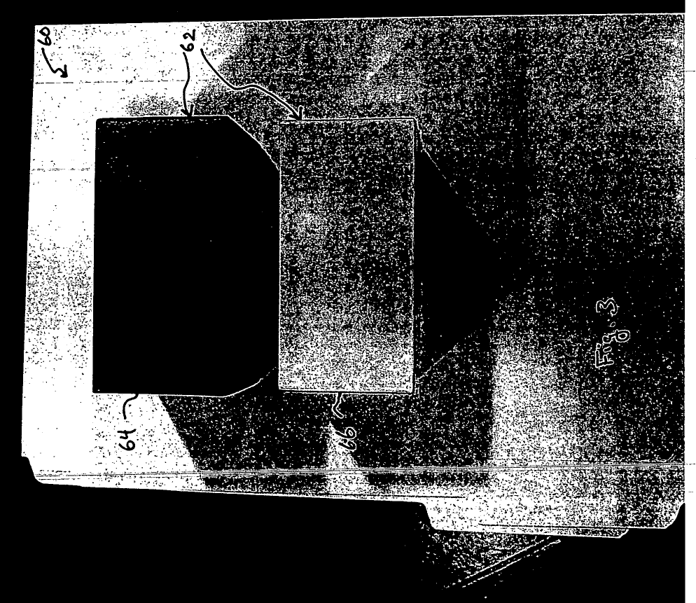

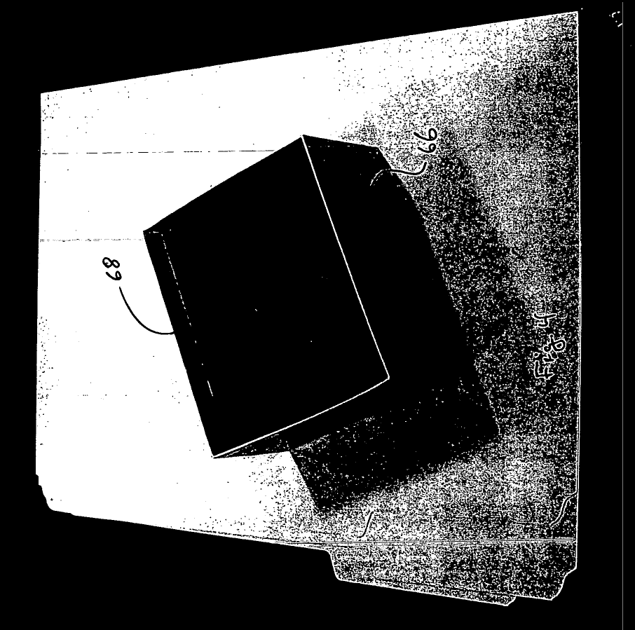

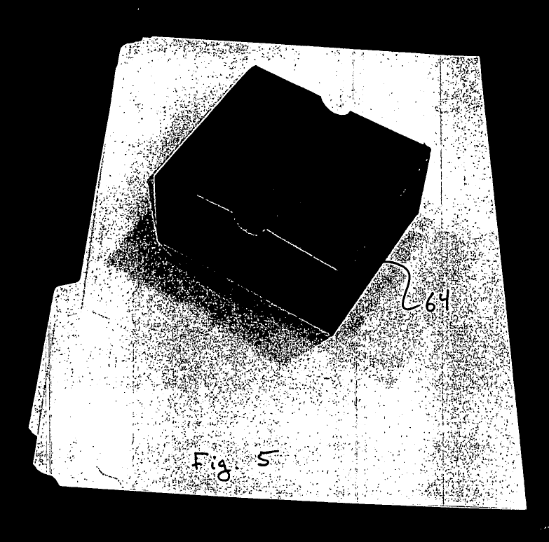

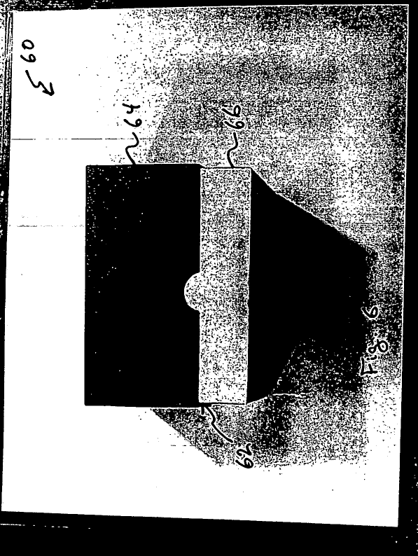

An apparatus according to the invention may also include a container 60. Container 60 is any structure or device in which the other components or structures of the apparatus may be temporarily or permanently stored, such as any type of metal, plastic and/or cardboard box, or a paper or plastic wrapping, or some combination of a plastic, metal and/or cardboard box and plastic and/or paper wrapping. Preferably container 60 is a two-piece box 62 as shown in FIGS. 3-6. Box 62 is preferably made of plastic or cardboard, has a top section (or lid) 64 and a bottom section (or base) 66 having a cavity 68. Lid 64 is sized to be slightly larger than base 66 so that it can fit over base 66, as shown in FIG. 6. In this embodiment, all other components of the apparatus fit entirely inside box 62 (although the apparatus need not fit entirely inside a container 60). Container 60 is preferably scented with a scent associated with an object. The scent is applied to container 60 in any of the afore-described methods and container 60 preferably has a microencapsulated formulation applied thereto by a printing process.

Optionally, the apparatus may include a board, paper pad, one or more sheets of paper, timer, blind fold, dye or dice, or other structures that can be used to enhance game play. Some or all the indicia of identity of the object, correct spelling of the name of the object, indicia of one or more clues of the identity of the object and/or indicia of one or more things related to the object may be on or part of any structure of the apparatus, including container 60 (when an indicia is printed on or stored inside of container 60, it is referred to herein as being contained in container 60).

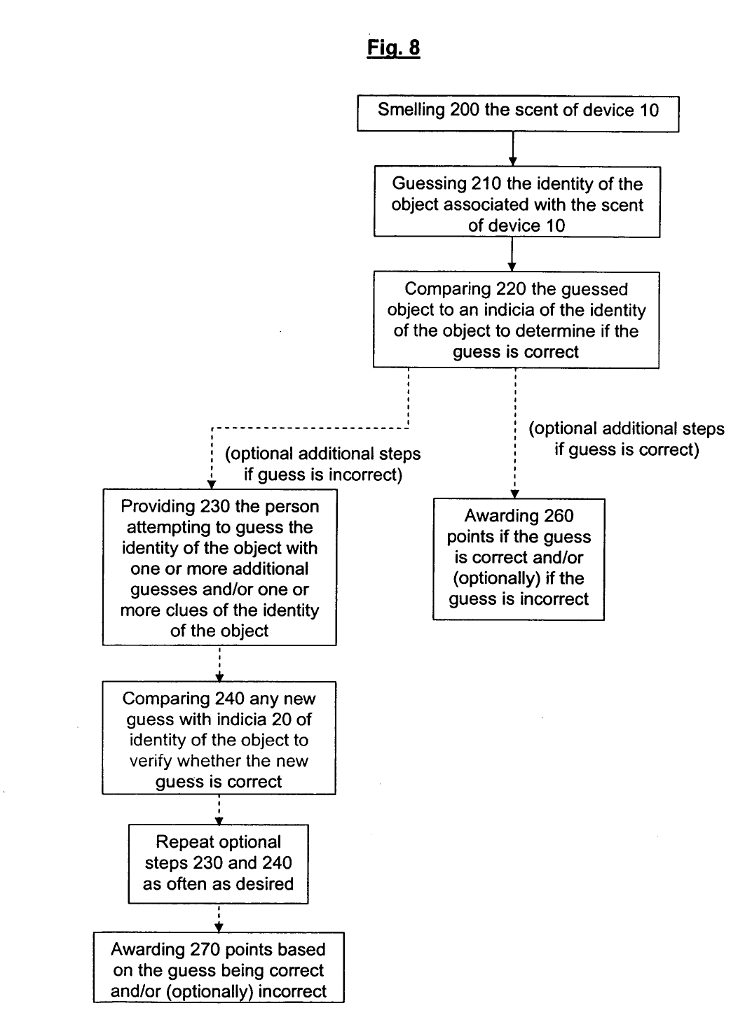

Turning now to FIG. 8, a method for identifying a scent according to the invention preferably comprises at least the steps of:

a. smelling 200 the scent on a device 10 according to the invention;

b. guessing 210 the object associated with the scent, and

c. comparing 220 the guessed object to an indicia of identity of the object to determine if the guess is correct.

The step of smelling the scent may be done in any manner. Preferably the user or another person holds device 10 close enough to the user to enable the user to smell the scent, or the user moves close enough to device 10 to smell the scent. If a microencapsulated formula is used, some of the capsules may be ruptured or dissolved by applying a stimulus before the user smells the scent. As shown in FIG. 7, after the user smells the scent, he or she guesses the identity of the object associated with the scent. The guess is then compared to indicia 20 of identity of the object to determine if the guess is correct or incorrect. (In every context herein, an incorrect guess or incorrect identification is defined as one in which the user either guesses incorrectly or cannot make a guess.)

Points may be awarded 260 or 270 for correct and/or incorrect answers (the awarded points for an incorrect answer are preferably negative, such as by taking away points). Points may be anything, including a number score, prize, or any indicia, device, or method reflecting a result. The points may be based simply on the guess being correct or may be based on the number of guesses or number of clues provided prior to a correct guess being made. If a player is allowed multiple guesses or provided multiple clues, the score awarded may be less than those awarded if the guess had been correct the first time and/or prior to the provision of clues.

Turning to FIGS. 8-10, a method according to the invention may optionally include one or more of the following steps:

a. providing 230 additional guesses and/or one or more clues of the identity of the object, the one or more clues preferably are provided in the event a guess of the identity of the object is incorrect, but potentially are provided at any time, including before the first guess is made;

b. comparing 240 any new guess with the indicia of identity of the object to verify whether the new guess is correct (steps 230 and 240 may be repeated as often as desired);

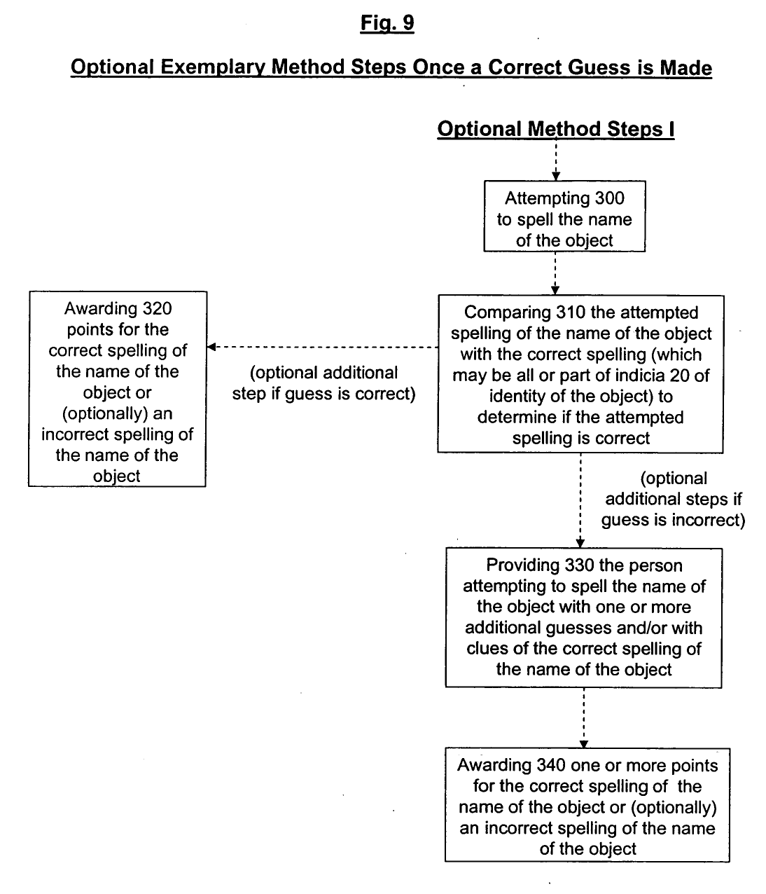

c. attempting 300 to spell the name of the object (see FIG. 9);

d. comparing 310 the attempted spelling 300 of the object with the correct spelling of the name of the object (which could be all or part of indicia 20 of the identity of the object) to determine if the attempted spelling is correct;

e. providing 330 the person attempting to spell the name of the object with one or more additional guesses and/or with one or more clues of the correct spelling of the name of the object, the one or more clues preferably provided in the event an attempted spelling is incorrect;

f. awarding 320 or 340 points for the correct spelling of the name of the object and/or (optionally) for an incorrect spelling;

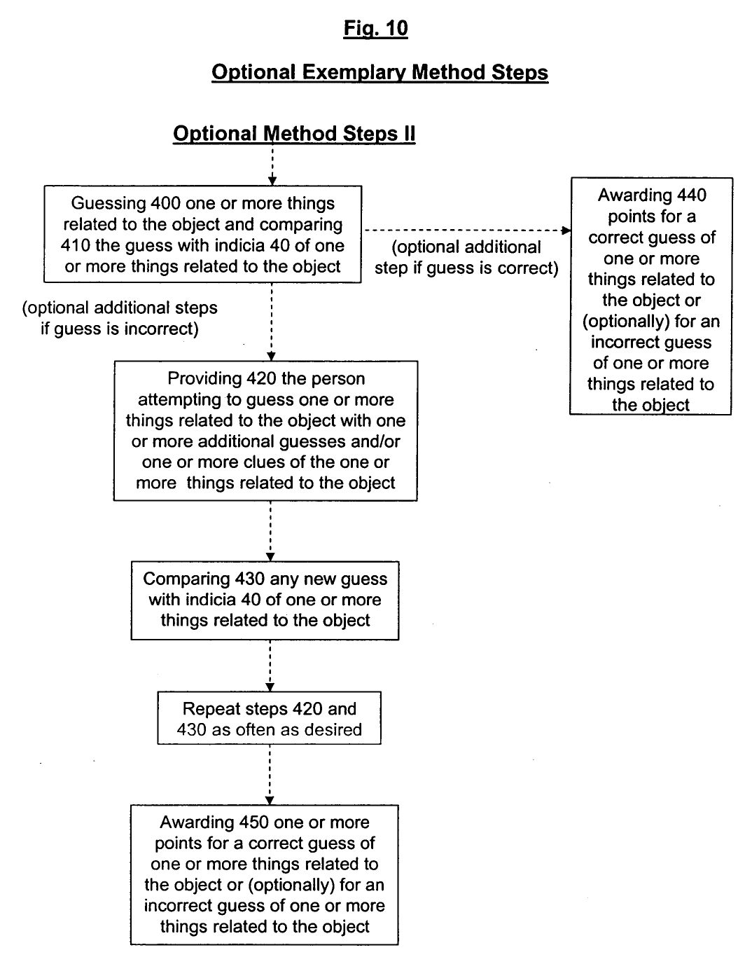

g. guessing 400 one or more things related to the object, such as similar objects or the general category into which the object falls, and comparing 410 the guess with indicia 40 of things related to the object (see FIG. 10);

h. providing 420 the person attempting to guess one or more things related to the object with one or more additional guesses and/or one or more clues of things related to the object, the clues preferably provided after an incorrect guess; and

i. awarding 440 or 450 points for a correct guess of one or more things related to the object and/or (optionally) for an incorrect guess of one or more things related to the object.

If an aspect of a specific embodiment of the invention is to attempt to correctly spell the name of the object associated with a scent, the apparatus will include the correct spelling of the name of the object, which preferably would be included as part of indicia 20.

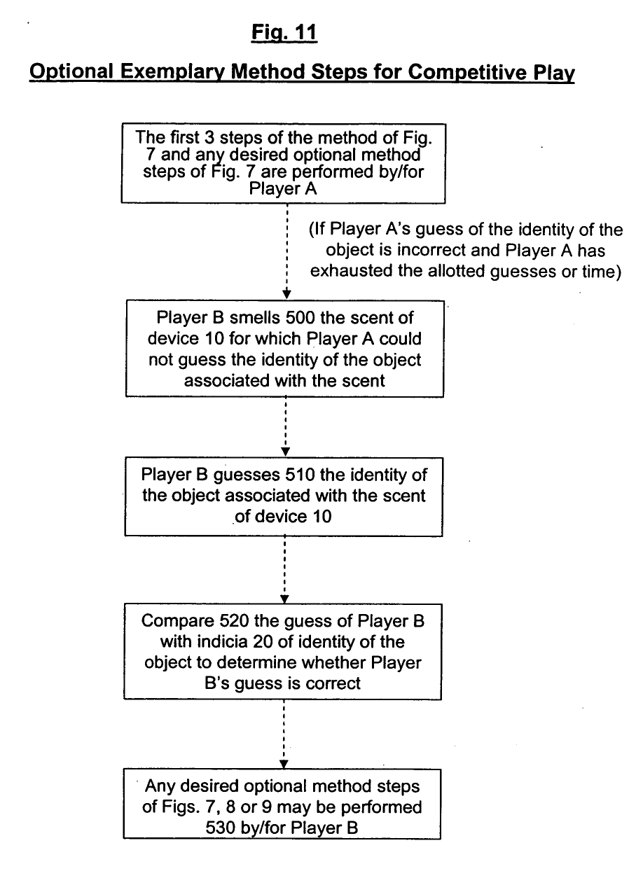

If there is at least a first user (referred to in the Figures as Player A) and a second user (referred to in the Figures as Player B) the multiple users may engage in competitive play, as shown in FIGS. 11-13. Optional method steps for competitive play include one or more of the following:

a. the first 3 steps of the method of FIG. 8 and any desired optional method steps of FIG. 8 are performed by/for Player A ( see FIG. 11);

b. if Player A's guess of the identity of the object is incorrect and Player A has exhausted the allotted guesses or time, Player B smells 500 the scent of device 10 for which Player A could not guess the identity of the object associated with the scent;

c. Player B guesses 510 the identity of the object associated with the scent of device 10; and

d. the guess of Player B is compared 520 with indicia 20 of identity of the object to determine whether Player B's guess is correct.

Other optional method steps for competitive play comprise one or more of the following:

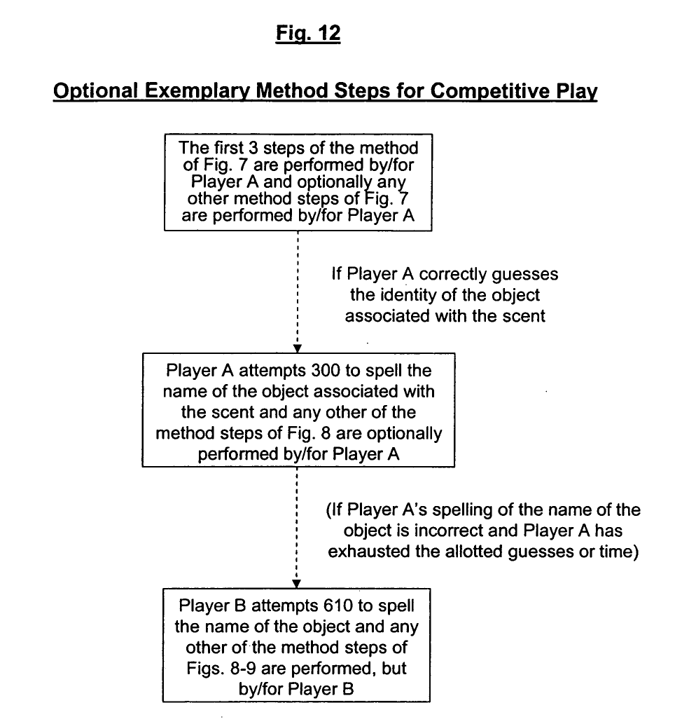

a. the first 3 steps of the method of FIG. 8 and any optional method steps of FIG. 8 are performed by/for Player A (see FIG. 12);

b. Player A attempts 300 to spell the name of the object and any other of the method steps of FIG. 9 are optionally performed by/for Player A; and

c. if Player A incorrectly spells the name of the object, Player B attempts 610 to spell the name of the object and any other of the method steps of FIGS. 9-10 are performed by/for Player B.

Other optional method steps for competitive play comprise one or more of the following:

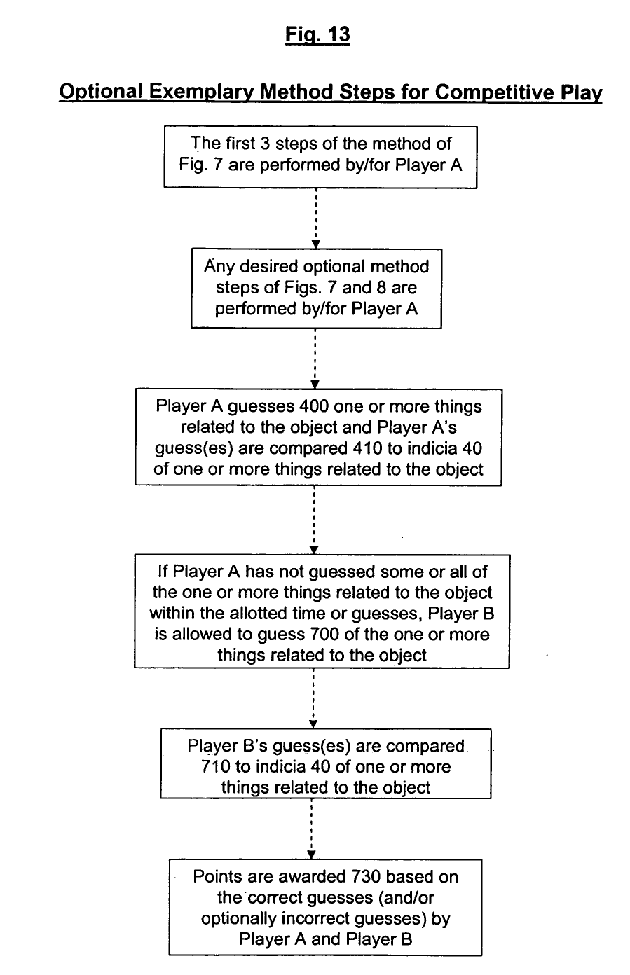

a. Player A guesses 400 one or more things related to the object ( see FIG. 13);

b. if Player A has not guessed some or all of the one or more things related to the object within the allotted time or guesses, Player B guesses 700 one or more things related to the object; and

c. points are awarded 730 based on the correct guesses (and/or, optionally, incorrect guesses) by Player A and Player B.

Players or teams may compete according to the methods shown in FIGS. 11 -13.

Having thus described different embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof.

Unless expressly stated in the written description or claims, the steps of any method recited in the claims may be performed in any order capable of yielding the desired result.

What is claimed is:

1. An apparatus for attempting to identify an object associated with a scent, the apparatus comprising:
(a) a device having a scent, the scent associated with an object and being sufficiently strong to be detected by a person smelling the device;
(b) indicia of the identity of the object, the indicia capable of communicating to a person the identity of the object associated with the scent, and comprising one or more of the group consisting of (i) one or more words, (ii) one or more pictorial representations, and (iii) one or more Braille characters; and
(c) a container for packaging the device, the container having a scent, the scent associated with an object and being sufficiently strong to be detected by a person smelling the container;
wherein a person smells the scent of the device and guesses the identity of the object associated with the scent, and then compares the guess to the indicia of the identity of the object to determine if the guess is correct.

2. An apparatus for attempting to identify an object associated with a scent, the apparatus comprising:
(a) a device having a scent, the scent associated with an object and being sufficiently strong to be detected by a person smelling the device; and
(b) indicia of the identity of the object, the indicia capable of communicating to a person the identity of the object associated with the scent, and comprising one or more of the group consisting of (i) one or more words, (ii) one or more pictorial representations, and (iii) one or more Braille characters;
wherein a person smells the scent of the device and guesses the identity of the object associated with the scent, and then compares the guess to the indicia of the identity of the object to determine if the guess is correct.

3. The apparatus of claim 2 ,wherein the device is a playing card that includes a first face and a second face.

4. The apparatus of claim 3 wherein the scent is on at least the first face of the playing card.

5. The apparatus of claim 3 wherein the entire playing card is scented.

6. The apparatus of claim 2 wherein the scent is generated by a microencapsulated formula on the device.

7. The apparatus of claim 3 wherein the scent is generated by a microencapsulated formula on the card.

8. The apparatus of claim 2 wherein the indicia of identity of the object is on the device.

9. The apparatus of claim 2 wherein the indicia of the identity of the object is not on the device.

10. The apparatus of claim 3 wherein the indicia of the identity of the object is on the playing card.

11. The apparatus of claim 2 wherein the device is a machine that generates a scent.

12. The apparatus of claim 2 that further includes indicia of one or more clues of the identity of the object.

13. The apparatus of claim 12 wherein the indicia of one or more clues of the identity of the object comprises one or more of the group consisting of (a) one or more words, (b) one or more pictorial representations, and (c) one or more Braille characters.

14. The apparatus of claim 12 wherein the device is a playing card and the indicia of one or more clues of the identity of the object is on the playing card.

15. The apparatus of claim 2 that further includes indicia of one or more things related to the object.

16. The apparatus of claim 2 wherein the device is shaped like the object associated with the scent.

17. The apparatus of claim 2 wherein the device comprises the color of the object associated with the scent.

18. The apparatus of claim 2 that comprises a plurality of devices.

19. The apparatus of claim 18 wherein there are at least 5 devices.

20. The apparatus of claim 18 wherein there are at least 20 devices.

21. The apparatus of claim 18 wherein each of the plurality of devices has a scent that is different than the scent of each of the other of the plurality of devices.

22. The apparatus of claim 2 wherein the object is selected from one or more of the group consisting of root beer, banana, strawberry, apple, chocolate, cola, vanilla, chocolate, mint, peanut butter, orange, grapefruit, peach, cinnamon, leather, ocean, burning rubber, cut grass, carrot, hard-boiled egg, butterscotch, strawberry, blueberry, bubblegum, lavender, rose, pepper, clove, coffee, tea, tomato sauce, oregano, mustard, magic marker, pumpkin pie, raspberry, lemon, vinegar, dill, pineapple, sour apple, almond extract, licorice, cotton candy, popcorn, cherry, pine, chicken noodle soup, macaroni and cheese, hot dog, ginkgo, olive, jasmine, ginger, cedar, juniper, myrrh, truffle, chocolate chip cookies, pizza and eucalyptus.

23. A container for containing (a) a plurality of devices, each of the plurality of devices having a scent associated with an object wherein the scent is sufficiently strong to be detected by a person smelling the device, and (b) indicia of the identity of the object: the container having a scent assonated with an object, wherein the scent is sufficiently strong to be detected by a person smelling the container.

24. The container of claim 23 wherein the object is selected from one or more of the group consisting of: root beer, banana, strawberry, apple, chocolate, cola, vanilla, chocolate, mint, peanut butter, orange, grapefruit, peach, cinnamon, leather, ocean, burning rubber, cut grass, carrot, hard-boiled egg, butterscotch, strawberry, blueberry, bubblegum, lavender, rose, pepper, clove, coffee, tea, tomato sauce, oregano, mustard, magic marker, pumpkin pie, raspberry, lemon, vinegar, dill, pineapple, sour apple, almond extract, licorice, cotton candy, popcorn, cherry, pine, chicken noodle soup, macaroni and cheese, hot dog, ginkgo, olive, jasmine, ginger, cedar, juniper, myrrh, truffle, chocolate chip cookies, pizza and eucalyptus.

25. The container of claim 23 that is scented by having a microencapsulated formula applied thereto.

26. The container of claim 23 that comprises a box.

27. A method for teaching a person to identify an object associated with a scent, the method utilizing an apparatus including a plurality of devices, the method comprising:
a person smelling the scent of one of the devices, the scent being sufficiently strong to be detected by the person;
the person guessing the identity of an object associated with the scent; and
comparing the guess to indicia of identity of the object to determine if the guess is correct.

28. The method of claim 27 that further includes the step of scoring one or more points for correctly guessing the identity of the object.

29. The method of claim 27 that further includes the step of providing one or more clues of the identity of the object.

30. The method of claim 29 that further includes the step of scoring one or more points if the object is guessed correctly, the points being less than those awarded if the object were guessed correctly without the provision of the one or more clues.

31. The method of claim 27 that further includes the steps of (a) attempting to spell the name of the object after correctly identifying the object, and (b) comparing the attempted spelling to the correct spelling of the name of the object to verify whether the attempted spelling is correct.

32. The method of claim 31 that further includes the step of scoring one or more points if the object is spelled correctly.

33. The method of claim 27 that further includes the steps of (a) guessing one or more things related to the object after the object has been correctly identified, and (b) comparing the guessed one or more things to an indicia of one or more things related to the object to verify whether the guess of one or more things related to the object is correct.

34. The method of claim 34 that further includes the step of scoring points for correctly guessing one or more things related to the object.

35. The method of claim 34 that further includes the step of providing one or more clues of things related to the object if the one or more things related to the object is guessed incorrectly.

36. The method of claim 35 wherein the points scored for correctly guessing one or more things related to the object are less than correctly guessing one or more things related to the object before the one or more clues were provided.
